(19) United States
(12) Patent Application Publication
(10) Pub. No.: US 2021/0052110 A1
(43) Pub. Date: Feb. 25, 2021

(54) Mollusk Grilling Assembly

(71) Applicant: Donald Schoux, Benicia, CA (US)

(72) Inventor: Donald Schoux, Benicia, CA (US)

(21) Appl. No.: 16/545,852

(22) Filed: Aug. 20, 2019

(51) Int. Cl. A47J 37/07

(52) U.S. Cl. CPC A47J 37/0786

(57) ABSTRACT

A mollusk grilling assembly for cooking mollusks over a cooking grill includes a stand that is positionable on a cooking grill. A basket is coupled to the stand thereby facilitating the basket to be supported above the cooking grill. The basket has a pair of channels therein and each of the channels is continuous such that each of the channels forms a closed loop. Each of the channels forms a V shape thereby facilitating each of the channels to cradle shells of mollusks thereby facilitating the mollusks to be cooked.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to grilling devices and more particularly pertains to a new grilling device for cooking mollusks over a cooking grill.

### (2) Description of Related Art Including Information Disclosed Under 37 CFR 1.97 and 1.98

The prior art relates to grilling devices.

### (h) BRIEF SUMMARY OF THE INVENTION

An embodiment of the disclosure meets the needs presented above by generally comprising a stand that is positionable on a cooking grill. A basket is coupled to the stand thereby facilitating the basket to be supported above the cooking grill. The basket has a pair of channels therein and each of the channels is continuous such that each of the channels forms a closed loop. Each of the channels forms a V shape thereby facilitating each of the channels to cradle shells of mollusks thereby facilitating the mollusks to be cooked.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a mollusk grilling assembly according to an embodiment of the disclosure.

FIG. 2 is a top view of an embodiment of the disclosure.

FIG. 3 is a cross sectional view taken along line 3-3 of FIG. 2 of an embodiment of the disclosure.

FIG. 4 is an exploded perspective view of an embodiment of the disclosure.

### (j) DETAILED DESCRIPTION OF THE INVENTION

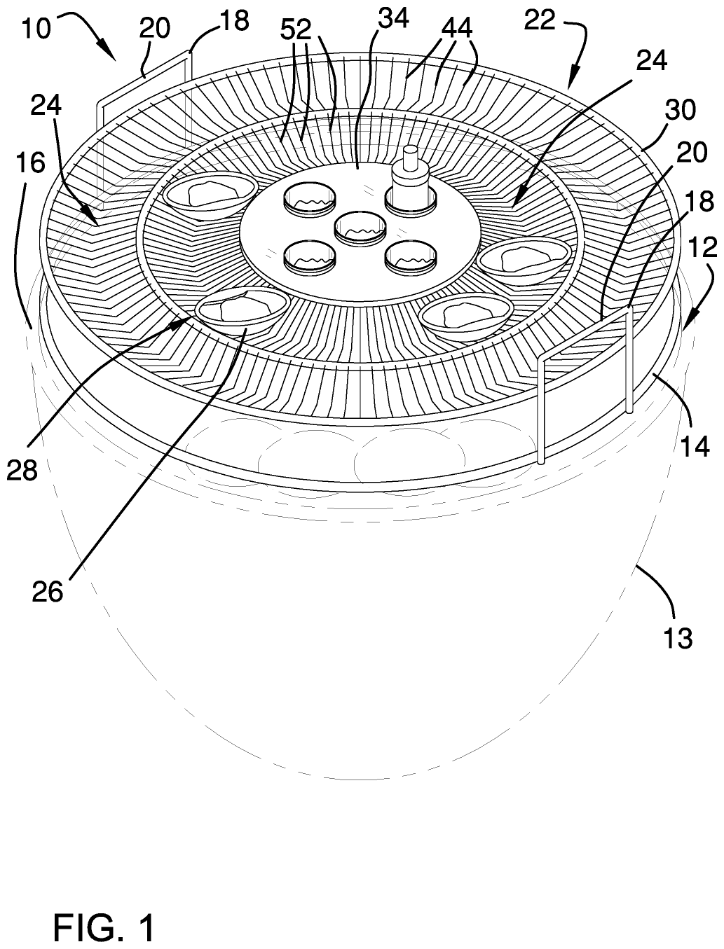

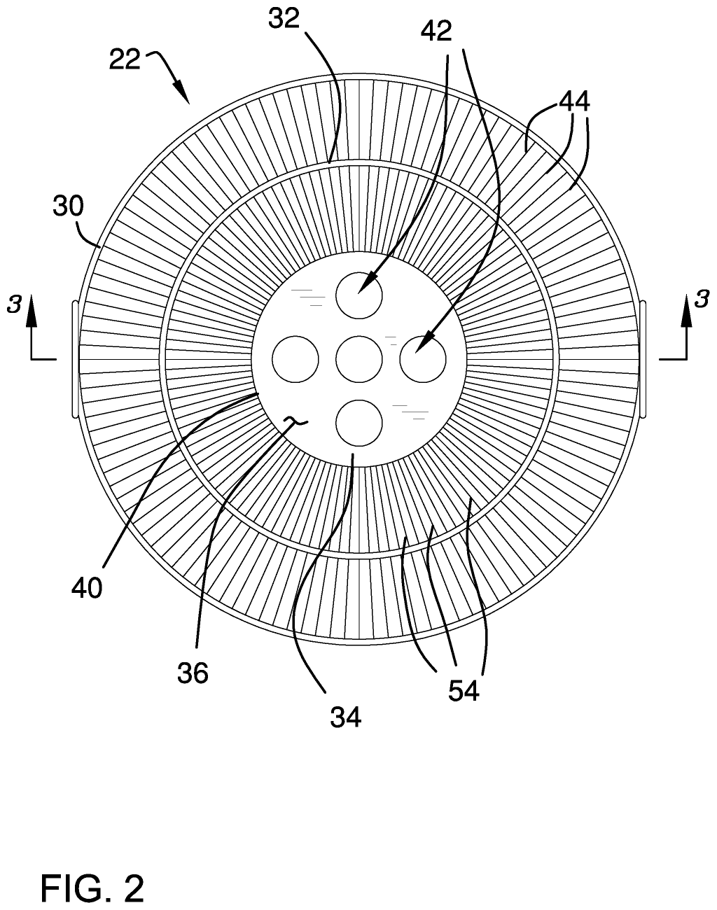

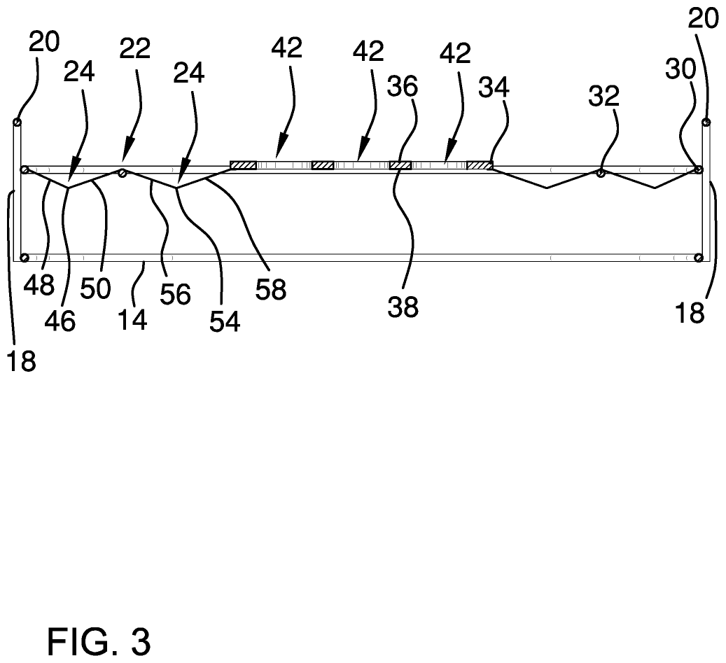

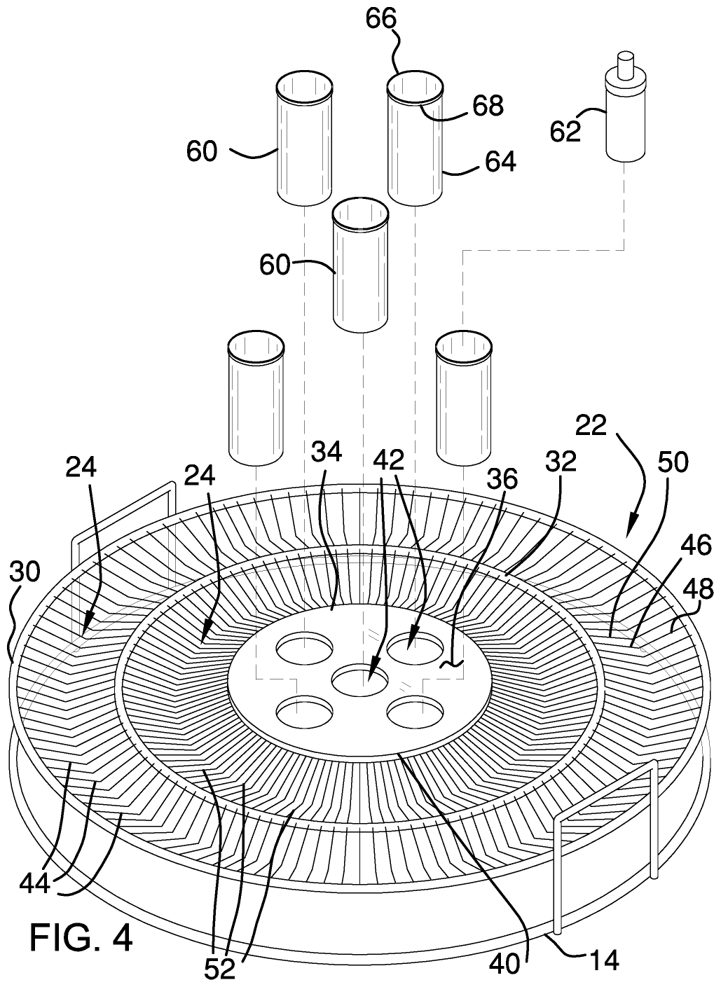

With reference now to the drawings, and in particular to FIGS. 1 through 4 thereof, a new grilling device embodying the principles and concepts of an embodiment of the disclosure and generally designated by the reference numeral 10 will be described.

As best illustrated in FIGS. 1 through 4, the mollusk grilling assembly 10 generally comprises a stand 12 is positionable on a cooking grill 13. The stand comprises a support ring 14 that is positionable on a cooking grill 13. The cooking grill 13 may be a charcoal grill or other type of cooking grill that has a circular top end 16. A pair of uprights 18 is each coupled to and extends away from the support ring 14. Each of the uprights 18 is vertically oriented when the support ring 14 is positioned on the cooking grill 13. The uprights 18 are positioned on opposite sides of the support ring 14 from each other. Additionally, each of the uprights 18 may have a height of approximately 2.0 inches and each of the uprights 18 includes a central member 20 that is horizontally oriented for gripping.

A basket 22 is coupled to the stand 12 thereby facilitating the basket 22 to be supported above the cooking grill 13. The basket 22 has a pair of channels 24 therein. Each of the channels 24 is continuous such that each of the channels 24 forms a closed loop. Additionally, each of the channels 24 forms a V shape. In this way each of the channels 24 can cradle shells 26 of mollusks 28 thereby facilitating the mollusks 28 to be cooked. The mollusks 28 may be oysters on the half shell, clams or any other mollusk.

The basket 22 comprises an outer ring 30 that is coupled to each of the uprights 18 having the outer ring 30 being spaced from the support ring 14. The outer ring 30 lies on a plane that is oriented parallel to the support ring 14. The basket 22 includes an inner ring 32. The basket 22 further includes a disk 34 that has a top surface 36, a bottom surface 38 and a perimeter edge 40. The disk 34 has a plurality of openings 42 extending through the top surface 36 and the bottom surface 38. The outer ring 30 may have a diameter of approximately 36.0 inches, the inner ring 32 may have a diameter of approximately 24.0 inches and the disk 34 may have a diameter of approximately 12.0 inches.

The basket 22 includes a plurality of first members 44 that each extends between the outer ring 30 and the inner ring 32. The inner ring 32 is oriented concentric with the outer ring 30. The first members 44 are spaced apart from each other and are distributed around an entire circumference of each of the outer ring 30 and the inner ring 32. Each of the first members 44 has a bend 46 therein to define a first half 48 of the first members 44 forming an angle with a second half 50 of the first members 44. Additionally, the bend 46 on each of the first members 44 is directed downwardly such that the first half 48 and the second half 50 of each of the first members 44 defines a respective one of the channels 24 in the basket 22. The first half 48 and the second half 50 may form an angle of approximately 34.0 degrees with each other. Additionally, the first half 48 of each of the first members 44 may from an angle of approximately 73.0 degrees with the outer ring 30.

The basket 22 includes a plurality of second members 52 that each extends between the inner ring 32 and the perimeter edge 40 of the disk 34. In this way the perimeter edge 40 of the disk 34 forms a concentric circle with respect to the inner ring 32. The second members 52 are spaced apart from each other and are distributed around an entire circumference of each of the outer ring 30 and perimeter edge 40 of the disk 34. Each of the second members 52 has a bend 54 therein to define a first half 56 of the second members 52 forming an angle with a second half 58 of the second members 52. The bend 54 on each of the second members 52 is directed downwardly such that the first half 56 and the second half 58 of each of the second members 52 defines a respective one of the channels 24 in the basket 22. The first half 56 of each of the second members 52 and the second half 58 of each of the first members 44 may form an angle of approximately 34.0 degrees with each other. Additionally, the second half 58 of each of the second members 52 may form an angle of approximately 73.0 degrees with the perimeter edge 40 of the disk 34.

A plurality of canisters 60 is provided and each of the canisters 60 is removably coupled to the basket 22 and each of the canisters 60 is comprised of a thermally conductive material. Each of the canisters 60 has a sauce bottle 62 being positionable therein to heat the sauce bottle 62. The sauce bottle 62 may contain any fluid condiment that might be eaten with the mollusks 28. Each of the canisters 60 has an outer wall 64 and a top end 66, and the top end 66 of each of the canisters 60 is open. The outer wall 64 of each of the canisters 60 has a lip 68 that is coextensive with the top end 66. Each of the canisters 60 is insertable into a respective one of the openings 42 in the disk 34 having the lip 68 on each of canisters 60 resting on the top surface 36 of the disk 34.

In use, the stand is positioned on the cooking grill 13 thereby orienting each of the outer ring 30 and the inner ring 32 on a horizontal plane. In this way mollusk shells 26 can be placed on each of the channels 24 in the basket 22 for cooking the mollusks 28 over the cooking grill 13. Moreover, oysters on the half shell can be placed in each of the channels 24 for cooking the oysters on the half shell over the cooking grill 13. Additionally, each of canisters 60 can be partially filled with water for warming one or more of the sauce bottle 62s. The central member 20 of each of the uprights 18 is gripped to remove the basket 22 and the stand from the cooking grill 13.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mollusk grilling assembly being configured to support oysters over a cooking grill for cooking, said assembly comprising:
a stand being positionable on a cooking grill;
a basket being coupled to said stand thereby facilitating said basket to be supported above the cooking grill, said basket having a pair of channels therein, each of said channels being continuous such that each of said channels forms a closed loop, each of said channels forming a V shape thereby facilitating each of said channels to cradle shells of mollusks thereby facilitating the mollusks to be cooked; and
a plurality of canisters, each of said canisters being removably coupled to said basket, each of said canisters being comprised of a thermally conductive material, each of said canisters having a sauce bottle being positionable therein wherein each of said canisters is configured to heat the sauce bottle.

2. The assembly according to claim 1, wherein said stand comprises:
a support ring being positionable on a cooking grill; and
a pair of uprights, each of said uprights being coupled to and extending away from said support ring, each of said upright being vertically oriented when said support ring is positioned on the cooking grill, said uprights being positioned on opposite sides of said support ring from each other.

3. The assembly according to claim 2, wherein said basket comprises an outer ring, said outer ring being coupled to each of said uprights having said outer ring being spaced from said support ring, said outer ring lying on a plane being oriented parallel to said support ring.

4. The assembly according to claim 3, wherein said basket comprises an inner ring.

5. The assembly according to claim 4, wherein said basket includes a plurality of first members, each of said first members extending between said outer ring and said inner ring having said inner ring being oriented concentric with said outer ring, said first members being spaced apart from each other and being distributed around an entire circumference of each of said outer ring and said inner ring.

6. The assembly according to claim 5, wherein each of said first members has a bend therein to define a first half of said first members forming an angle with a second half of said first members.

7. The assembly according to claim 6, wherein said bend on each of said first members is directed downwardly such that said first half and said second half of each of said first members defines a respective one of said channels in said basket.

8. The assembly according to claim 5, wherein said basket includes a disk having a top surface, a bottom surface and a perimeter edge, said disk having a plurality of openings extending through said top surface and said bottom surface.

9. The assembly according to claim 8, wherein said basket includes a plurality of second members, each of said second members extending between said inner ring and said perimeter edge of said disk such that said perimeter edge of said disk forms a concentric circle with respect to said inner ring, said second members being spaced apart from each other and being distributed around an entire circumference of each of said outer ring and perimeter edge of said disk.

10. The assembly according to claim 9, wherein each of said second members has a bend therein to define a first half of said second members forming an angle with a second half of said second members, said bend on each of said second members being directed downwardly such that said first half and said second half of each of said second members defines a respective one of said channels in said basket.

11. A mollusk grilling assembly being configured to support oysters over a cooking grill for cooking, said assembly comprising:
a stand being positionable on a cooking grill, said stand comprising:
a support ring being positionable on a cooking grill; and
a pair of uprights, each of said uprights being coupled to and extending away from said support ring, each of said upright being vertically oriented when said support ring is positioned on the cooking grill, said uprights being positioned on opposite sides of said support ring from each other;
a basket being coupled to said stand thereby facilitating said basket to be supported above the cooking grill, said basket having a pair of channels therein, each of said channels being continuous such that each of said channels forms a closed loop, each of said channels forming a V shape thereby facilitating each of said channels to cradle shells of mollusks thereby facilitating the mollusks to be cooked, said basket comprising:
an outer ring, said outer ring being coupled to each of said uprights having said outer ring being spaced from said support ring, said outer ring lying on a plane being oriented parallel to said support ring;
an inner ring;
a disk having a top surface, a bottom surface and a perimeter edge, said disk having a plurality of openings extending through said top surface and said bottom surface;
a plurality of first members, each of said first members extending between said outer ring and said inner ring having said inner ring being oriented concentric with said outer ring, said first members being spaced apart from each other and being distributed around an entire circumference of each of said outer ring and said inner ring, each of said first members having a bend therein to define a first half of said first members forming an angle with a second half of said first members, said bend on each of said first members being directed downwardly such that said first half and said second half of each of said first members defines a respective one of said channels in said basket; and
a plurality of second members, each of said second members extending between said inner ring and said perimeter edge of said disk such that said perimeter edge of said disk forms a concentric circle with respect to said inner ring, said second members being spaced apart from each other and being distributed around an entire circumference of each of said outer ring and perimeter edge of said disk, each of said second members having a bend therein to define a first half of said second members forming an angle with a second half of said second members, said bend on each of said second members being directed downwardly such that said first half and said second half of each of said second members defines a respective one of said channels in said basket; and
a plurality of canisters, each of said canisters being removably coupled to said basket, each of said canisters being comprised of a thermally conductive material, each of said canisters having a sauce bottle being positionable therein wherein each of said canisters is configured to heat the sauce bottle, each of said canisters having an outer wall and a top end, said top end of each of said canisters being open, said outer wall of each of said canisters having a lip being coextensive with said top end, each of said canisters being insertable into a respective one of said openings in said disk having said lip on each of canisters resting on said top surface of said disk.
